(19) United States
(12) Patent Application Publication
(10) Pub. No.: US 2003/0057053 A1
(43) Pub. Date: Mar. 27, 2003

(54) Apparatus and method for sheet discrimination

(76) Inventors: Mitsunari Kano, Seto (JP); Toshiro Uemura, Nissin (JP); Eiji Mizuno, Owariasahi (JP)

Correspondence Address: MCDERMOTT, WILL & EMERY, 600 13th Street, N.W., Washington, DC, 20005-3096, US

(21) Appl. No.: 10/226,230

(22) Filed: Aug. 23, 2002

(30) Foreign Application Priority Data
Aug. 28, 2001 (JP) 2001-258298

(51) Int. Cl. G06K 7/00; G07D 7/00; G07F 7/04; G06K 9/00

(52) U.S. Cl. 194/207

(57) ABSTRACT

The present invention relates to a technique of improving an apparatus for sheets discrimination with accuracy. Ultraviolet rays are illuminated to a sheet, such as banknote, and a light-receiving sensor 4 and 5 receive fluorescence emitted by a sheet using the light reflected from a sheet and ultraviolet rays as an excitation light. Moreover, the light-receiving sensor 5 receives the diffused and reflected light irradiated to a reflector 1 installed under a sheet conveyor 17. Correcting the reflective light and fluorescence detected based on strength of the irradiating light in the state without a banknote enables the discrimination with a high degree of accuracy even if an error is included in the irradiating light caused by the problems such as an aging of illuminant.

### BACKGROUND OF THE INVENTION

1. Field of the Invention

The present invention generally relates to an apparatus for sheet discrimination that discriminates sheets true or false.

2. Description of the Related Art

Various automated systems, which handle banknotes or various kinds of valuable securities, have become widely used. These automated systems have discrimination apparatus that discriminates sheets such as banknotes.

The discrimination can be carried out by using reflective light or second luminescence light obtained by illuminating the prescribed irradiating light such as ultraviolet rays and infrared rays. The second luminescence light includes, for instance, fluorescence or infrared rays luminescence emitted from the excited ink and sheet by the irradiating light. A kind of sheets, which are incapable of emitting fluorescence, are often used for banknotes or valuable securities to prevent from being forged while sheets used in ordinary cases are capable of emitting fluorescence with ultraviolet rays. The discrimination thus can be carried out based on detecting the presence or absence of fluorescence. Another method for preventing forged banknotes is to print the pattern with ink that emits fluorescence to a specific portion. The fluorescent characteristics are effective in detecting the presence or the absence of such a pattern as well. In addition to the fluorescence, detecting the reflective characteristics enables the discrimination as reflectivity of banknotes to a specific irradiating light is distinguishable from sheets used in ordinary cases.

For the improved accuracy of the discrimination as described, the irradiation light is required to illuminate by regulated strength with a high degree of accuracy. For instance, JP10-208105A disclosed a technique of compensating for temperature drift of the irradiating light. In this technology, the impedance on an irradiation circuit could be changed in proportion to the ambient temperature of illuminant so as to compensate for the change of the irradiating light by the temperature.

In some cases in the related art, however, an error occurs in strength of the irradiation light, which is caused by an aging of illuminant and a difference of manufacture, and decreases the discrimination accuracy. For instance, a light strength of a light emitting diode and a fluorescent tube as illuminant generally decreases as a total lighting time becomes longer. It is not possible to achieve satisfactory accuracy by compensation for only the lighting time, because of the individual difference of the relationship between the lighting time and the decrease in accuracy. The accuracy for the temperature drift is also hard to secure by the compensation based on only the ambient temperature since the amount of luminescence is changing individually corresponding to the temperature of an internal gas and a chip.

For the improved discrimination with accuracy, it is assumed to compensate the change in irradiating light by using a standard fluorescence reflector having known second luminescent characteristics. In the actual situation, however, it is hard and not practicable to obtain the fluorescent material for the standard fluorescent reflector available stably for a long time. Amendments based on the strength of the irradiating light detected directly is not practicable, because very high degree of accuracy is required in order to set a portion of the light receiving sensor detecting the irradiating light that is generally illuminated in a thin beam.

### SUMMARY OF THE INVENTION

In order to provide a technique of improving the accuracy for the discrimination such as banknotes and variable securities while the irradiating light includes an error caused by an aging of illuminant and other factors, an apparatus for discrimination that discriminates sheets using the reflective characteristics or the second luminescence characteristics to the prescribed irradiating light comprises an illuminant, a detector, a diffusely reflective board, a correction module and a discrimination module. Here sheets means a paper, a sheet film and a card, or the like for examples, by which value is given. In the specification hereof, examples of ‘sheets’ include, materials having substantially flat surface, for instance, a banknote, a lot ticket such as lottery, a ballot ticket of bike race, horse race or boat race, an admission ticket, a utility ticket of highway, telephone or various facilities, various securities, credit obligation, stock certificate and book coupon.

The illuminant illuminates the irradiating light by strength set beforehand corresponding to the reflective characteristics and the second luminescence characteristics of the sheet to be discriminated. For instance, the light emitting diode, the ultraviolet rays lamp, and the infrared rays light emitting diode can be used as an illuminant.

The detector detects at least one of the reflective light with the irradiation from the sheet or the second luminescence light obtained from the sheet using the irradiating light as an excitation light. Comparing thus detected light with the known characteristics respectively enables the discrimination.

The illuminant illuminates the irradiation light not only to the sheet to be discriminated but also to the discrimination region of the sheet device, but with the sheet not yet placed there. The diffusely reflective board diffuses and reflects the irradiating light illuminated in such a “sheet unplaced” position for discrimination status with which the sheet is not set. The detector detects strength of the light reflected from the diffusely reflective board. Here the term “diffusion” means that the luminous flux of the reflective light has larger dimension than the one of the irradiating light, which occurs even along narrow dimension, approximately about the section where the detector is capable of detecting the reflective light.

The correction module corrects an error between the detected strength and the standard one. Three methods are available; correcting strength of the irradiating light in the illuminant, correcting the detected result of the detector, or correcting the threshold of standard value. The discrimination module discriminates sheets based on the detected result of the detector with this correction applied.

In accordance with the apparatus for sheet discrimination of the present invention, the irradiating light detected in the state with the sheet unplaced enables the detection of an error included therein, which achieves the improved sheet discrimination with accuracy. In this case, there is an advantage that the irradiating light can be detected comparatively easily by using the diffusely reflective board. The use of the diffusely reflective board, in fact, enables the luminous flux of the irradiating light to be thick so as to ease positional accuracy of the detector. As a result, it becomes possible to compensate for the irradiating light and achieve the stable improvement of the discrimination with accuracy.

It is preferred to coat a reflective surface of the diffusely board with an inorganic substance in terms of durability and easiness to be manufactured despite of possibility with various materials. For example, enamel, ceramic, alumina, or a transparent material supported by a prescribed reflective material is available as an inorganic substance.

It is preferable to use one light-receiving sensor for receiving both the reflective light from the sheet when the illuminant illuminates the sheet and the reflective light from the diffusely board when the sheet is not in position for illumination, which simplify the composition of the apparatus.

Additional objects, advantages and novel features of the embodiments will be set forth in part in the description which follows, and in part will become apparent to those skilled in the art upon examination of the following and the accompanying drawings or may be learned by production or operation of the embodiments. The objects and advantages of the inventive concepts may be realized and attained by means of the methodologies, instrumentalities and combinations particularly pointed out in the appended claims.

### BRIEF DESCRIPTION OF THE DRAWINGS

The drawing figures depict preferred embodiments by way of example, not by way of limitations. In the figures, like reference numerals refer to the same or similar elements.

FIG. 1 schematically illustrates an exemplary construction of an automatic teller machine (hereafter referred to as ‘ATM’) 15;

FIG. 2 illustrates an exemplary structure of a discrimination device 16 in detail; and

FIG. 3 is a flow chart showing an exemplary discrimination processing.

### DESCRIPTION OF THE PREFERRED EMBODIMENTS

Some embodiments as an apparatus for banknote discrimination are described below in the following sequence.

A. General Construction;

B. Construction of a discrimination device;

C. Processing of discrimination;

D. Modifications;

A. General Construction:

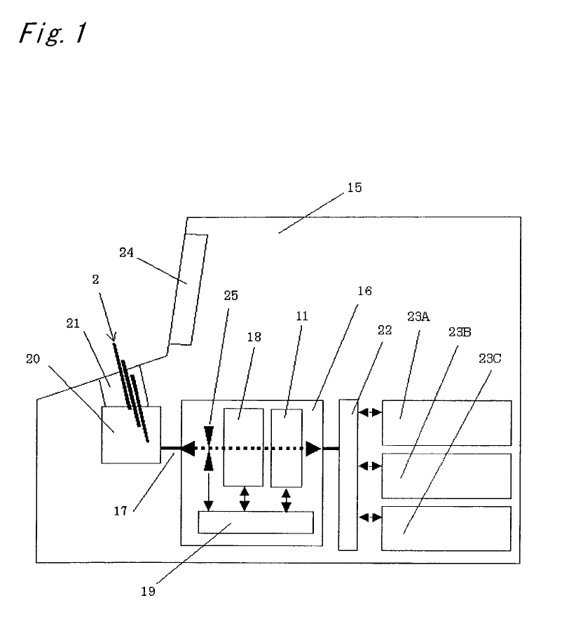

FIG. 1 schematically illustrates the construction of an automatic teller machine (hereafter referred to as ‘ATM’) 15 in one embodiment. ATM 15 is an apparatus executing deposits and withdrawals of banknotes through a insert-delivery opening 21. The insert-delivery opening 21 allows put in/put out of banknotes being discriminated in the case of deposits and withdrawals respectively.

A separation unit 20 separates incoming banknotes by one each and sent off to a sheet conveyor 17. A sheet conveyor 17 conveys banknotes by using a sheet conveyor, such as belts. A banknote 2 is carried first to a discrimination device 16 installed on the sheet conveyor 17 in order to be discriminated about such items; which kind of denomination and whether true or false. It is preferred that so-called reflux-way ATM is equipped with the function for discriminating broken and dirty banknotes as well.

ATM 15 of this embodiment has three cashboxes, 23A, 23B and 23C, corresponding to currency denominations and the purpose. The cashbox 23A stores the banknotes that are incapable of being recycled because of heavy break or dirt. The cashboxes 23B and 23C store the reusable fair certificates corresponding to the denomination. After completion of the discrimination, the transportation destination of banknote 2 is switched by a diverter 22 so as to store the banknote 2 into any one of the cashboxes according to the discriminated result. A touch panel 24 is installed on ATM 15 that displays information such as the amount of the received money in response to the operation of deposits.

When the user inputs the amount of money with touch panel 24 for a withdrawals, the banknotes corresponding to the input amount can be conveyed from cashboxes 23B and 23C to a insert-delivery opening 21 in the opposite direction of the deposits case. In this embodiment, the banknotes through the discrimination device 16 are not discriminated in withdrawals, however, it is acceptable to execute the discrimination for confirming the banknotes being put out.

The outline composition of discrimination device 16 is also shown in a figure. The discrimination device 16 employs two ways; discrimination with optical characteristic and the one with magnetic characteristic. An optical discriminator 11 executes the former case and a magnetic discriminator 18 the latter. A discrimination controller 19 controls those operations. The discrimination controller 19 is a microcomputer which includes CPU, ROM, and RAM internally. Discrimination controller 19 begins the discrimination processing when detecting the insertion of banknotes with an insert sensor 25 installed on the sheet conveyor 17.

B. Construction of a Discrimination Device

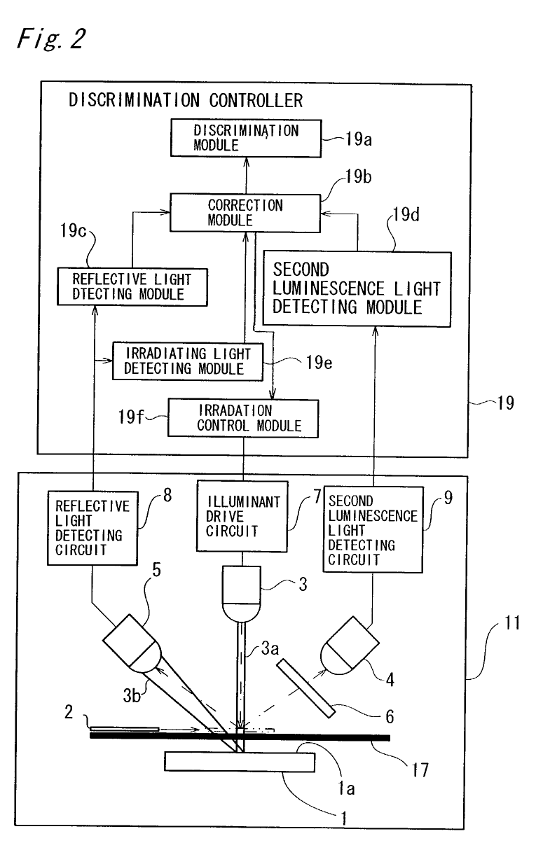

FIG. 2 illustrates an exemplary structure of a discrimination device 16 in detail. The structure of the optical discriminator 11 and the functional blocks of the discrimination controller 19 are shown here. In this embodiment, each functional block is implemented by a software module. As described above, discrimination controller 19 has CPU, ROM RAM, etc. The software to implement the discriminator functions may be stored in ROM. For example, the CPU performs these functions by executing the software stored in ROM. In this case, ROM is an apparatus readable medium, but the term “apparatus readable medium” as used herein refers to any medium that participates in providing instructions and/or data to programmable processor (CPU) for execution or other processing. Such a medium may take many form, including but not limited to carrier waves and physical media for transporting such waves, non-volatile storage media, and volatile storage media. Non-volatile media include, for example, optical or magnetic disks, such as ROM, or Hard disc. However, the functions of the modules can be implemented by hardware modules with proprietary circuits. The magnetic discriminator 18, which is employed for discrimination here as well as the optical discriminator 11, is not shown in FIG. 2.

First, the principle of an optical discrimination is explained. A sheet, which does not emit fluorescence despite of the irradiation there of by ultraviolet rays, is often used with a pattern for counterfeit prevention printed using fluorescence ink. Accordingly, illuminating ultraviolet rays to a sheet enables the discrimination of validity of a sheet by detecting whether fluorescence is emitted from a surface of a sheet or not, and the presence or absence of the above noted pattern. In addition, it is also possible to discriminate a valid sheet based on the reflective characteristics to ultraviolet rays where reflectivity of valid sheets is lower than ordinary sheets. In this embodiment, an example of the discrimination using only ultraviolet rays is discussed, on the other hand, a visible light or an infrared light can be used for discrimination.

The optical discriminator 11 has illuminant 3 to illuminate with the irradiating light used for discriminating banknotes. The illuminant 3 is a source (or sources) for emitting radiant energy of type (or types), which here, is useful in validating one or more particular kinds of sheets, in the example, banknote. In this embodiment, discrimination can be executed by using ultraviolet rays as described. As illuminant 3, for instance, a light emitting diode and an ultraviolet lamp can be used. An infrared light emitting diode can be utilized as illuminant 3 in the case of discrimination with infrared rays. Illuminant 3 emits light by the operation of an illuminant drive circuit 7 that impresses illuminant 3 with voltage based on a control signal from an irradiation controller 19f in the discrimination controller 19. By enabling adjustment for impedance depending on a control signal, it may be possible to correct the amount of emission from illuminant 3.

The irradiating light reflects on the surface of the banknote 2 when the sheet is located in the position which the irradiating light from illuminant 3 illuminates on a sheet conveyor 17. At the same time, the banknote 2 fluoresces ultraviolet rays as an excitation light (refer to two points chained lines in the figure). The optical discriminator 11 has a sensor to detect those reflective light and fluorescence. In this embodiment, the reflective light can be detected by a light-receiving sensor 5 and a reflective light detecting circuit 8. A fluorescence can be detected by a light-receiving sensor 4 and a second luminescence light detecting circuit 9. A filter 6, which passes of fluorescence, is installed in front of the light-receiving sensor 4 so that only the fluorescence is incident to the light-receiving sensor 4. The light-receiving sensor 4 and 5 use elements, such as photo transistors and photo diodes, each of which outputs the voltage corresponding to strength of the incidented light. Each of the reflective light detecting circuit 8 and the second luminescence light detecting circuit 9 can utilize an amplification circuit and an A/D converter that converts an amplified voltage output from the light-receiving sensor 4 or 5 into a digital signal. The combination of the respective detector is comprised light-receiving sensor 4, 5 with the light detecting circuit 8, or the second luminescence light detecting circuit 9 form a detector device.

The light receiving sensor 5 and the reflective light detecting circuit 8 can be used to detect strength of the irradiating light as well as the irradiating light reflected from the banknote 2. In this embodiment, the optical discriminator 11 has a reflective board 1 under the sheet conveyor 17. Reflective is incident to the light-receiving sensor 5 by reflection against the reflective board 1, before the banknote 2 is transported (located on the solid line in the figure). Holes are installed in a sheet conveyor 17 to avoid shutting out this light path.

The reflective board 1 has a diffusion surface 1a on its upper surface. A relatively thin beam 3a irradiated by the illuminant 3 becomes beam 3b that diffuses on diffusion surface 1a and incident in the light-receiving sensor 5. Here, diffusion means that the dimension of the luminous flux of beam 3b broadens more than the one of beam 3a. Diffusing and reflecting beams can provide advantages in which positional accuracy between illuminant 3, reflector 1 and the light receiving sensor 5 that is required for detecting the irradiating light can be eased, and the irradiating light can be detected in a stable manner.

The preferable material of the reflector 1 is an inorganic quality material, where deterioration by ultraviolet rays is not caused easily, such as alumina, glass, ceramic, or a transparent material supported by a prescribed reflective material. Especially among glass, enamel is suitable.. Enamel can control reflectivity by selecting the over coat being applied on the surface. In addition, enamel has advantageous features of high abrasion resistance, guard against dirt adhered and prevention from electrostatic during travel of banknotes as the surface of enamel is made of glass.

The discrimination controller 19 discriminates banknotes by processing various signals obtained from the optical discriminator 11, as shown diagrammatically in each function block. Here, the function block for optical discrimination of a banknote is shown. In addition, the discrimination controller 19 has a function block to carry out magnetic discrimination based on the input from the magnetic discriminator 18.

An irradiation control 19f controls the irradiation drive circuit 7 and illuminates ultraviolet rays as an irradiating light when detecting the approach of banknotes with an insert sensor 25. At this point, defused and reflected ultraviolet rays against the light reflector 1 will be incidents in the light-receiving sensor 5 as the banknote 2 has not yet reached the portion where ultraviolet is irradiated. An irradiating light detecting module 19e obtains and stores the digitized output from the light-receiving sensor 5 hereupon as irradiating light data, in response to light diffusely reflected from diffusion surface 1a.

The reflective light and the fluorescence obtained from the banknote 2 respectively are incident in the light-receiving sensor 5 and in the light-receiving sensor 4 when the banknote 2 is conveyed to the position where ultraviolet is irradiated. The second luminescence light detecting module 19d obtains and stores the digitized output from the light-receiving sensor 4 as second luminescence light data. At the same time, the reflective light detecting module 19c obtains and stores the digitized output from the light-receiving sensor 5 as sheet reflective light data, in response to light reflected by the banknote 2 or other sheet,

A correction module 19b corrects the data stored into the reflective light detecting module 19c and the second luminescence light detecting module 19d, based on the strength data of irradiating light that is stored into the irradiating light detecting module 19e. The correction module 19b compensates for the influence on the data stored into the reflective light detecting module 19c and the second luminescence light detecting module 19d for some errors in strength of the irradiating light, which are caused by an aging of illuminant, a difference of manufacture and temperature drift, may be included. The discrimination module 19a receives thus corrected data to carry out the discrimination of banknotes from other (invalid) sheet.

C. Processing of Discrimination

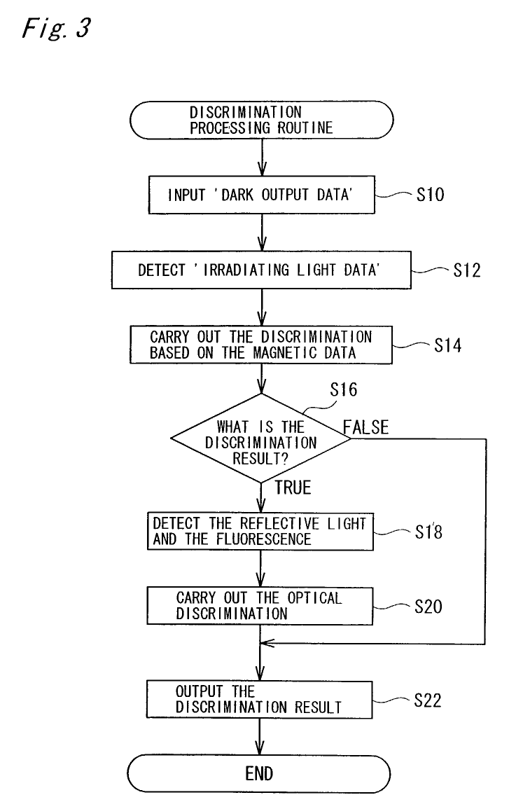

FIG. 3 is an exemplary flow chart showing a discrimination processing that is carried out by the discrimination controller 19 in response to the insertion of the banknote 2.

Upon starting the processing, the discrimination controller 19 receives the output from the light-receiving sensor 4 and the light-receiving sensor 5 at the time when the irradiating light has not yet illuminated as ‘dark output data’, which is used for Point zero adjustment (Step S10). The irradiating light is illuminated from the illuminant 3 to detect ‘the irradiating light data’ afterwards. Those steps correspond to the processing in the irradiating light detecting module 19e as described below.

Next, the discrimination controller 19 carries out the discrimination employing the magnetic data based on the magnetic characteristics detected by a magnetic discriminator 18(step S14). The banknote 2 can be discriminated based on the judgment whether the banknote 2 shows magnetic characteristics peculiar to a real certificate. As a result, the optical discrimination processing is skipped as further discrimination is unnecessary when judged as a bogus certificate (step S16), and the discrimination result is output (step S22), in this case the “invalid” result.

The irradiating light illuminates a banknote to carry out an optical discrimination processing (step S20) based on the detected result of the reflective light data and the fluorescence data (step S18), and output the discrimination result (step S22) when judged as a valid certificate through the magnetic data discrimination processing (step S16).

The discrimination result indicating a real certificate can be provided only when the sheet is judged as real through the discrimination both with the magnetic data and with the optical data, accordingly, the judgment as a bogus certificate from either of two discriminators' results in false.

The content of the optical discrimination processing is as follows. The discrimination controller 19 corrects the reflective light data and the fluorescence data detected through step S18 using the dark output data and the irradiating light data obtained at step S10 and S12 respectively. An example of the expression for the correction is shown below.

Fluorescence data offset S=(S1−S0)/(L−R0);

Reflective light data offset R=(R1−R0)/(L−R0);

S1: Fluorescence data;

S0: Dark output data from light-receiving sensor 4;

L: Irradiating light data;

R1: Reflective light data; and

R0: Dark output data from light-receiving sensor 5

The purpose of subtracting the dark output data S0 and R0 respectively in the above expressions is for point zero adjustment. The correction in the above expressions indicates the processing to regularize respectively the fluorescent data and the reflective light data adjusted to point zero using the irradiating light data. It may be possible to multiply the above expressions by standard strength of the irradiating light to carry out the correction for the detected result corresponding to the irradiation illuminated at standard strength.

This correction enables the compensation for the influence on the reflective light data and the fluorescence data caused by an error, which occurred in the difference between the current irradiating light and the preset standard strength. In this embodiment, the correction by the above expression can be applied based on the assumption that the relationship between the reflective light and the fluorescence data, and strength of the irradiating light is kept in a linear configuration. The expression for the correction may be a nonlinear operational expression when the relationship is nonlinear. Moreover, it may be possible to carry out the correction by using a map shows the relationship between the reflective light data and the fluorescence data, and strength of the irradiating light instead of the above expression for the correction.

The discrimination controller 19 carries out the discrimination based on the fluorescence data offset and the reflective light data offset obtained through the above steps. Discrimination can be performed, for instance, based on the judgment whether strength of the fluorescence detected from the surface of a banknote is comparable to the value of the real certificate or not, or whether the specific pattern printed to a real certificate with fluorescence ink in advance is detected or not. Moreover, comparing the reflectivity of ultraviolet rays with the value of the real certificate enables discrimination as well. Here the above three objects are used together for the discrimination; however, it may be possible to use only some of them. For instance, the discrimination processing with the reflective light data is not supposed to require the fluorescence data, whereby the structure of the discrimination device 16 can be simplified by omitting some functions such as the light-receiving sensor 4.

The discrimination device 16, which carries out the discrimination processing with the correction of the reflective light data and the fluorescence data based on the irradiating light data, enables the discrimination with a high degree of accuracy uninvolved with an error in the irradiating light. In addition, the use of the diffusion and the reflective from the reflective board 1 can achieve alleviation in accuracy of position required for the light-receiving sensor 5, easy fabrication and stable accuracy.

In this embodiment, the light-receiving sensor 5 can be shared for processing to acquire both the irradiating light data and the reflective data. In addition, using the discrimination based on the fluorescence data and the one based on the reflective light together enables the improved discrimination with a high degree of accuracy.

In the above embodiment, reflective data and the fluorescence data can be corrected based on the irradiating light data. Instead of correcting detected reflective data and fluorescence data, it is possible to obtain similar effect as the above embodiment, by changing each threshold standard value as expected value of a valid sheet based on the detected light value from the diffusely reflective board, and comparing non-corrected detected values and corrected standard values.

D. Modifications:

In the previous embodiment, the reflective data and the fluorescence data, or standard data can be corrected based on the irradiating light data. The impedance of the illuminant drive circuit 7, on the other hand, may be controlled based on the irradiating light in order to illuminate the irradiating light at standard strength. It is also acceptable to carry out both the control of the irradiating light and the correction of the reflective data and the fluorescence data at the same time.

Although an object in the previous embodiment is limited to the discrimination for banknotes, this invention can be adopted not only to banknotes but various kinds of sheets, which can be discriminated by the reflective light or the second luminescence light against the irradiating light. Here ‘sheets’ includes, for instance, a banknote, a lot ticket such as lottery, a ballot ticket of bike race, horse race or boat race, an admission ticket, a utility ticket of highway, telephone or various facilities, various securities, credit obligation, stock certificate and book coupon, which is made of a paper, a sheet film or a card.

In the previous embodiment, the case where the irradiating light data is acquired before the conveyer of banknote 2 is illustrated (Step S12 in FIG. 3). The acquisition of the irradiating light data is executable according to various timing, for instance, after obtaining the reflective light data and the fluorescence data if the illuminant is not controlled. In the previous embodiment, the correction is carried out whenever sheet is turned on and a series of discrimination processing is performed, however, the configuration of the correction at a rate of once per several times is acceptable as well. It is remarkable that the above-mentioned correction carried out for every sheet, which is discussed in the previous embodiment, enables flexibly corresponding to the change of the temperature.

In the above embodiments, discrimination is performed for discrimination of the valid sheet, but these discrimination methods can be applied to discriminates kind of sheets, etc, in stead of discrimination for validity, by using light responsive characteristic of a sheet. According to above described embodiments, the use of the diffusely reflective board can achieve accuracy of the position and enables easy detection of the irradiating light itself. As a result, it can be accomplished to compensate for an error in the irradiating light and improve the accuracy of the discrimination with the irradiating light.

While the foregoing has described what are considered to be the best mode and/or other preferred embodiments, it is understood that various modifications may be made therein and that the invention or inventions disclosed herein may be implemented in various forms and embodiments, and that they may be applied in numerous applications, only some of which have been described herein. It is intended by the following claims to claim any and all modifications and variations that fall within the true scope of the inventive concepts.

What is claimed is:

1. An apparatus for sheet discrimination that discriminates sheets true or false by using a light responsive characteristic from a sheet with respect to an irradiating light, the apparatus comprising;
an illuminant to illuminate with the irradiating light;
a diffusely reflective board that diffuses and reflects the irradiating light when the sheet is not in position for illumination;
a detector that detects strength of a light obtained from the sheet using the irradiating light and the strength of reflective light from the diffusely reflective board;
a correction module that corrects at least one of the irradiating light of the illuminant and a value of detected light from the sheet for an error between the detected strength from the diffusely reflective board and a predetermined standard strength; and
a discrimination module that discriminates the sheet based on detected result from the sheet, the result from the sheet being corrected by the correction module.

2. An apparatus for sheet discrimination according to claim 1,
wherein the diffusely reflective board is coated with an inorganic substance on its reflective surface.

3. An apparatus for sheet discrimination according to claim 2,
wherein a material of the diffusely reflective board is selected from the groups consisting of enamel, ceramic, alumina and a transparent material supported by one of prescribed reflection material on its backside.

4. An apparatus for sheet discrimination according to claim 1,
wherein the detector detects strength of a reflection of the irradiating light from the sheet.

5. An apparatus for sheet discrimination according to claim 1,
wherein the detector detects strength of second luminescence light obtained from the sheet using the irradiating light as an excitation light.

6. An apparatus for sheet discrimination according to claim 1,
wherein the correction module corrects both the irradiating light of the illuminant and the value of detected light from the sheet, and
the discrimination module discriminates the sheet based on the corrected detected result.

7. An apparatus for sheet discrimination according to claim 4,
wherein the detector includes one light-receiving sensor receiving both the reflective light from the sheet and the reflective light from the diffusely reflective board.

8. An apparatus for sheet discrimination according to claim 1,
wherein the detector includes first light-receiving sensor receiving both the reflective light from the sheet and the reflective light from the diffusely reflective board, and second light-receiving sensor receiving second luminescence light obtained from the sheet using the irradiating light as an excitation light.

9. A method for sheet discrimination comprising the steps of;
(a) emitting irradiating light to the sheet;
(b) detecting strength of a light returned from the sheet when illuminated by the irradiating light;
(c) discriminating a characteristic of the sheet based on the detected light;
(d) illuminating a diffusely reflective board with the irradiating light when the sheet is not in a position for illumination by the irradiating light;
(e) detecting strength of reflective light from the diffusely reflective board; and
(f) correcting at least one of the strength of the irradiating light at step (a) and the detected light at step (b) so as to compensate for an error between the detected strength and a predetermined standard strength.

10. A method for sheet discrimination according to claim 9,
wherein the reflective surface of the diffusely reflective board is made of the inorganic substance.

11. A method for sheet discrimination according to claim 10,
wherein material of the diffusely reflective board is selected from the groups consisting of enamel, ceramic, alumina and a transparent material supported by one of prescribed reflection material on its backside.

12. A method for sheet discrimination according to claim 10, further comprising the step of;
(g) detecting sheet insertion;
wherein steps (d) through (f) are carried out after detecting the sheet insertion.

13. An apparatus for sheet discrimination comprising:
an illuminant that illuminates irradiating light to a sheet to be discriminated;
a discrimination module that carries out the discrimination by using light returned from the sheet being illuminated by the light and a standard value of the light expected from a valid sheet;
a detector that receives a reflection of the irradiating light illuminated from the illuminant; and
a correction module that corrects operation of the discrimination module depending on strength of the reflected light received by the detector.

14. An apparatus for sheet discrimination according to claim 13, wherein
the correction module corrects a value of detected light returned from the sheet being illuminated by the light depending on strength of the reflected light received by the detector.

15. An apparatus for sheet discrimination according to claim 13, wherein
the correction module corrects the standard value depending on strength of the reflected light received by the detector.

16. An apparatus for sheet discrimination according to claim 13, wherein:
a detector that receives the second luminescence light from the sheet,
the discrimination module uses the second luminescence light as the light from the sheet; and
the correction module corrects operation of the discrimination module relating to the second luminescence light.

17. An apparatus for sheet discrimination according to claim 13,
wherein the detector receives the light reflected from the sheet, and
the discrimination module carries out the discrimination using the light reflected from the sheet as the light from the sheet, and the correction module corrects the operation of the discrimination module relating to the light reflected from the sheet.

18. An apparatus for sheet discrimination according to claim 13, further comprising:
a light reflector which reflects irradiating light illuminated from the illuminant,
wherein the detector receives light reflected by the light reflector.

19. An apparatus for sheet discrimination according to claim 18, further comprising:
a sheet conveyor for carrying sheets, wherein a reflective surface of the light reflector and the illuminant are installed on opposite sides of the sheet conveyor each other.

20. An apparatus for sheet discrimination according to claim 19,
wherein the illuminant emits the irradiating light to the light reflector before sheets are carried through the sheet conveyor.

21. An apparatus for sheet discrimination according to claim 18,
wherein the light reflector is coated with an inorganic substance on its reflective surface.

22. An apparatus for sheet discrimination according to claim 18,
wherein a material of the light reflector is selected from the groups consisting of enamel, ceramic, alumina and a transparent material supported by one of prescribed reflection material on its backside.

23. An apparatus for sheet discrimination according to claim 13, further comprising:
an insert sensor detecting the supply of a sheet by the sheet conveyor,
wherein the correction module carries out the correction after the insert sensor detects the supply of sheet.

24. An apparatus for sheet discrimination according to claim 13,
wherein the illuminant emits ultraviolet rays as an irradiating light.

25. An apparatus for sheet discrimination according to claim 13,
wherein the correction module corrects strength of irradiating light of the illuminant depending on strength of the reflected light received by the detector.

26. An apparatus for sheet discrimination, comprising;
an optical discriminator which illuminates the sheet and a reflective board with irradiating light and detects a light from the sheet and a light from the reflective board, wherein the reflective board diffuses and reflects light when the sheet is not in position for processing by the optical discriminator, and
a discrimination controller to correct a value of detected light from the sheet based on a value of the detected light from the reflective board and discriminate the validity of the sheet based on the corrected value of the detected light from the sheet.

27. An apparatus for sheet discrimination, comprising;
an optical discriminator which illuminates the sheet with irradiating light and detects a light from the sheet and reflection of the irradiating light, and
a discrimination controller to correct a standard value of the light expected from a valid sheet based on strength of the detected reflection of the irradiating light, and to discriminate a validity of the sheet by using detected light from the sheet and corrected standard value.

28. An apparatus for sheet discrimination, comprising;
an optical discriminator which illuminates the sheet and a reflected board with irradiating light and detects a light from the sheet and a light from a reflective board, wherein the reflective board diffuses and reflects light when the sheet is not in a position for processing by the optical discriminator, and
a discrimination controller to control irradiating light intensity of the optical discriminator based on a value of detected light from the reflective board and to discriminate a validity of the sheet.

29. A software product for an apparatus for sheet discrimination having an optical discriminator and a discrimination controller, the product comprising:
at least one apparatus readable medium;
programming code, carried by the at least one medium, for execution by a processor of the discrimination controller, wherein execution of the programming code by the processor causes the discrimination controller to implement a series of steps, comprising:
(a) controlling the optical discriminator for emitting irradiating light to the sheet;
(b) controlling the optical discriminator for detecting a light returned from the sheet when illuminated by the irradiating light;
(c) discriminating a characteristic of the sheet based on the detected light;
(d) controlling the optical discriminator for illuminating a diffusely reflective board with the irradiating light when the sheet is not positioned for illumination by the irradiating light;
(e) controlling the optical discriminator for detecting strength of reflective light from the diffusely reflective board; and
(f) correcting at least one of the irradiating light at step (a) and the detected light at step (b) so as to compensate for an error between the detected strength and a predetermined standard strength.

30. A software product providing for an apparatus for sheet discrimination having an optical discriminator and a discrimination controller, the product comprising:
at least one apparatus readable medium;
programming code, carried by the at least one medium, for execution by a processor of the discrimination controller, wherein execution of the programming code by the processor causes the discrimination controller to implement a series of steps, comprising:
controlling the optical discriminator for emitting irradiating light to the sheet;
discriminating a characteristic of the sheet based on the detected light;
controlling the optical discriminator for detecting strength of a reflection of the irradiating light illuminated from the optical discriminator; and
correcting an operation of the discrimination controller so as to compensate for an error between the detected strength and a predetermined standard strength.
